(19) United States
(12) Patent Application Publication
(10) Pub. No.: US 2017/0289215 A1
(43) Pub. Date: Oct. 5, 2017

(54) METHOD AND SYSTEM FOR DATA STREAMING

(71) Applicant: University of Utah Research Foundation, Salt Lake City, UT (US)

(72) Inventors: Philip Lundrigan, Salt Lake City, UT (US); Sneha Kasera, Salt Lake City, UT (US); Makito Kano, Salt Lake City, UT (US)

(21) Appl. No.: 15/475,605

(22) Filed: Mar. 31, 2017

Related U.S. Application Data
(60) Provisional application No. 62/317,126, filed on Apr. 1, 2016.

(51) Int. Cl. H04L 29/06

(52) U.S. Cl. CPC H04L 65/4069; H04L 65/1069; H04W 84/042

(57) ABSTRACT

A technology is disclosed and described for distributing data packets. An example method may include creating a network connection between a source node and a gatherer server. Identifying a forwarder node available to connect to the source node via a wireless network. Sending connection protocol information to the forwarder node used by the forwarder node to connect to the gather server. Distributing the data packets to the forwarder node via the wireless network, whereupon the forwarder node transmits the data packets to the gather server over a forwarder cellular network utilized by the forwarder node and the gather server assembles the data using the data packets received from the forwarder node and sends the data to the client.

### RELATED APPLICATION

This application claims priority to U.S. Provisional Application No. 62/317,126, filed Apr. 1, 2016 which is incorporated herein by reference.

### GOVERNMENT INTEREST

This invention was made with government support under Grant No. 1302688 awarded by the National Science Foundation. The government has certain rights in the invention.

### BACKGROUND

Mobile computing devices such as smartphones have opened up new possibilities, from the way we organize our lives, to the way we communicate with each other. With smartphone cameras capable of capturing high dentition video, we are able to communicate in more meaningful ways. An example of this is live streaming video from a mobile computing device. Live streaming video allows people to share in an experience together, at the same time. Live streaming has become a popular activity for consumers with the advent of applications that allow sharing of live streaming. In such applications, a user shares a link to their live stream with friends through social media like FACEBOOK or TWITTER. Friends can connect and watch the video stream in real time, communicating with the person live streaming through comments and likes. Another example of a use for live streaming video is live action sports using small recording devices. These small recording devices are starting to be equipped with transmitters that can broadcast video to cellular capable devices to be uploaded in real time. Live streaming video opens up possibilities to new applications that might not have been possible before. In many cases, recording high quality video on a smartphone, beyond a short duration, is not necessarily an option because of the memory limitations and some form of live transmission is the only viable option.

While live video can be upstreamed at a high quality over high bandwidth Wi-Fi links, the same cannot be said about video transmission over cellular links for the following reasons. First, a cellular connection cannot always support the video data rate. Cellular networks have a difficult time keeping up with the demands of smartphone data usage and video streaming perpetuates this problem. Furthermore, cellular networks (as with most networks) have been optimized for fast speeds for download, but not upload. Second, spatio-temporal variations in cellular channel conditions can reduce the data rate in unpredictable ways. Even when standing still, the data rate of a cellular connection can vary dramatically over time. This makes it hard for any variable video rate method to work effectively. Third, smartphone video quality is increasing faster than that of cellular connections. Each year, new phones are equipped with better cameras and this is not slowing down. Ultra HD or 4K cameras are already being used in smartphones. Higher quality video may need a higher cellular data rate.

### SUMMARY

A technology is described for transmitting streaming data from a source node to a client using forwarder nodes and a gatherer server. A source node may comprise a mobile computing device configured to provide streaming data to a client by distributing the data to one or more forwarder nodes (e.g., nearby mobile computing devices) through a wireless network. The forwarder nodes independently forward the data to a gatherer server using cellular network connections utilized by the forwarder nodes. The gatherer server assembles the data as the data arrives from the forwarder nodes and streams the data to the client.

In one example, the source node establishes a network connection with a gatherer server. The network connection acts as a control channel used to manage transmission of streaming data to a client. The source node identifies one or more forwarder nodes that are in network communication with the source node via a wireless network (e.g., WI-FI DIRECT, BLUETOOTH, or the like) and are available to forward data packets to the gatherer server. The source node provides connection protocol information to the forwarder nodes that allows the forwarder nodes to connect to the gatherer server.

The source node distributes data packets to the forwarder nodes over the wireless network, and in turn, the forwarder nodes send the data packets to the gatherer server over the forwarder nodes' cellular network connections. In addition to distributing the data packets to the forwarder nodes, the source node can also send data packets to the gatherer server using the source node's cellular network connection. The gatherer server receives the data packets, assembles the data, and sends the data to the client.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1a is a diagram illustrating an example system for streaming data to a client by a source node using forwarder nodes and a gatherer server.

FIG. 1b is a block diagram that illustrates example components included in the system of FIG. 1a.

FIG. 2a-b are charts illustrating how an incentive model interacts in a simulator.

FIG. 3a-b are charts illustrating the results of sending packets using a linear distribution method and a jump distribution method.

FIG. 4a-c are charts that illustrate results of a varied data rate scenario for a linear method.

FIG. 5a-c are charts illustrating results of a varied data rate scenario for a jump method.

FIG. 6a-b are charts that illustrate jump method throughput test results for an indoor cellular trace.

FIG. 7a-b are charts illustrating jump method throughput test results for a dynamically changing environment.

FIG. 8 is a flow diagram illustrating an example method for streaming data to a client.

FIG. 9 is block diagram illustrating an example of a computing device that may be used to execute a method for transmitting streaming data.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

Definitions

In describing and claiming the present invention, the following terminology will be used.

The singular forms “a,” “an,” and “the” include plural referents unless the context clearly dictates otherwise. Thus, for example, reference to “a forwarder” includes reference to one or more of such devices and reference to “receiving” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, and combinations of each (e.g. A+B, B+C, A+C, and A+B+C).

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

The present technology is directed to streaming data from a source node to a recipient device using forwarder nodes and a gatherer server. In one example, the source node streams data to the recipient device by distributing data packets to the forwarder nodes using a short-range network, and the forwarder nodes forward the data packets to a gatherer server using the forwarder nodes' cellular network connections. The gatherer server assembles the data received from the forwarder nodes and provides the data to the recipient device. The present technology addresses the problem of upstreaming data, such as live video, over cellular network connections in the absence of some other network infrastructure, such as a WI-FI network. Specifically, the methods and systems disclosed herein utilize nearby forwarder nodes (e.g., smartphones and other networked connected computing devices) and associated collective cellular bandwidth to increase effective data upstream bandwidth. Due to the nature of cellular networks, each mobile computing device is provided some slice of the cellular network's bandwidth. The use of multiple computing devices to transmit on the cellular network in parallel can enhance the aggregate data transmission rate.

The present technology takes advantage of a mobile computing device's multiple wireless interfaces to distribute data to nearby computing devices, creating a small wireless network, such as by using WI-FI DIRECT or another network protocol. Other mobile computing devices then connect to the small wireless network. Parts of the data stream are sent to the connected mobile computing devices, which then upload their parts to a location in a wide-area network using their cellular network connections. The following advantages can be gained by using multiple cellular connections.

The total aggregate throughput may increase as more cellular network connections are used. Each cellular network connection contributes to a data rate, which when combined together, allows a streaming device to stream data as if the streaming device had a higher data rate.

Throughput may stabilize as more cellular network connections are used. Cellular networks can have highly fluctuating data rates. This effect can be minimized by aggregating multiple cellular network connections to upload data to a gatherer server. For example, when more cellular network connections are used and spatial diversity is higher, the less likely it is for each cellular network connection to fluctuate in the same way, causing the aggregate data rate to be smoother than the individual fluctuating data rates.

Using multiple cellular connections allows for cellular provider diversity. When two or more different cellular providers are used, the difference in cell tower placement and network particularities can lead to a more stable data streaming experience (e.g. video being particularly effected). For example, in a given location, one cellular provider might have a dead spot, but another cellular provider might not.

Using multiple mobile devices to cooperatively download stored data (but not upload live video) has been studied in prior work. The main focus of these systems has been improving the cellular network connection in the download direction, by increasing download speeds by using multiple cellular connections. The present technology is the first system that uploads real time data using multiple neighboring forwarder nodes.

Cooperative real time data uploading presents many challenges that have not been addressed in past work. One significant challenge is to ensure that data streaming content traveling through multiple paths arrives at the destination in a correct sequence. This is particularly important with respect to live streaming video. For example, without intervention, the video data may arrive out of sequence, rendering the video unplayable. The present technology solves this problem by intelligently estimating the actual data rates of the forwarder nodes and responding quickly to changes in cellular data rates. The present technology can also incorporate an incentive mechanism, based on an auction (e.g., knapsack auction) to incentivize cooperation among forwarder nodes. Thus, each forwarder node can be adjusted to reduce degree of out of order data packets received.

The present technology can be used in a variety of personal and professional settings. For example, the present technology allows families to connect when they are separated. News crews can live stream breaking news. There are numerous places where the present technology can augment existing data streaming workflows.

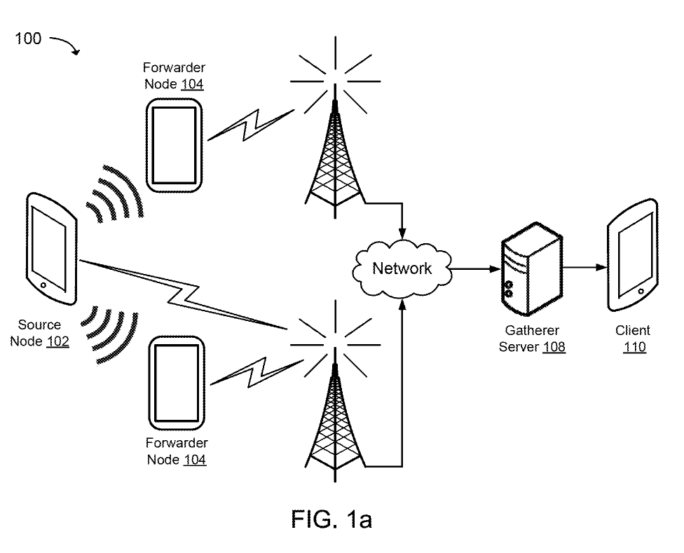

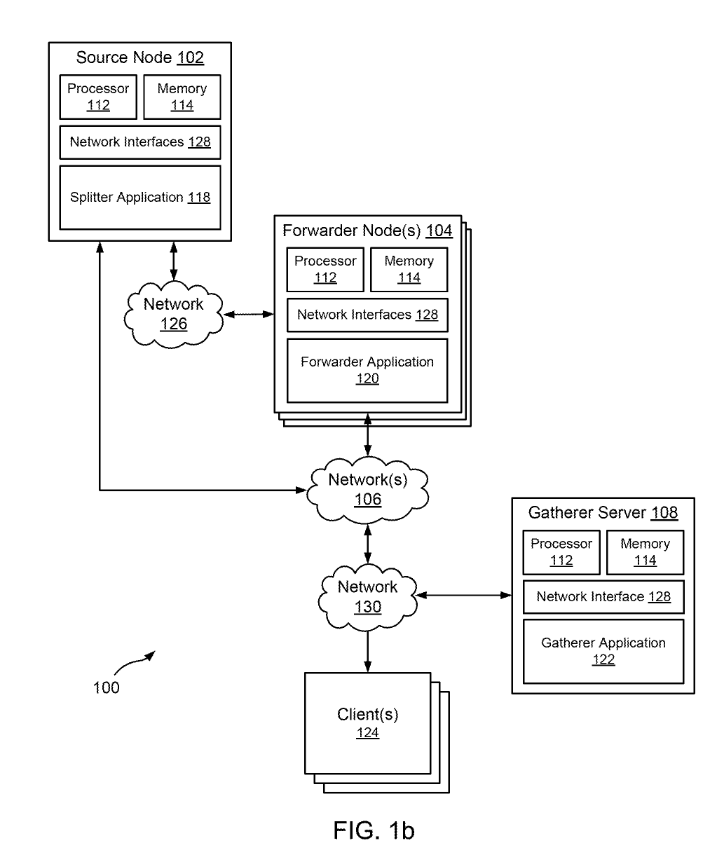

To further describe the present technology, examples are now provided with reference to the figures. FIG. 1a is a high level diagram illustrating an example of a system 100 for transmitting streaming data. As illustrated, the system 100 can include a source node 102, one or more forwarder nodes 104, a gatherer server 108, and one or more clients 110. FIG. 1a illustrates how each component can be connected to send data to a client 110.

In one example, the source node 102 broadcasts its availability to nearby forwarder nodes 104 that are willing to forward data to the gatherer server 108. The data can be any type of data. As non-limiting examples, the data can include video data captured by the source node 102, audio data captured by the source node 102, data stored on the source node 102, or other types of data.

The forwarder nodes 104 connect to the source node 102 through a short-range network (e.g., via WI-FI, BLUETOOTH, or similar network protocol) and the source node 102 splits the data into data packets for distribution to the forwarder nodes 104 via the short-range network. The forwarder nodes 104 then send the data packets to the gatherer server 108 via a cellular network. The source node 102 itself can also send a portion of the data to the gatherer server 108 via a cellular network 106. The gatherer server 108 receives the data from the forwarder nodes 104 and the source node 102, and the gatherer server 108 assembles the data. The gatherer server then provides the data to the client 110 via a network, such as the Internet, local-area network, or wide-area network.

To keep splitting of the data transparent to the client 110, the gatherer server 108 acts as a proxy for the source node 102 by receiving the data packets, assembling the data in the correct order, and providing the data to the client 110. The gatherer server 108 can also collect statistics about each forwarder node 104 and send feedback to the source node 102, allowing the source node 102 to use the statistics to distribute the data packets to the forwarder nodes 104.

FIG. 1b illustrates components of the example system 100 on which the present technology may be executed. The source node 102 includes one or more processors 112, memory devices 114, and network interfaces 128 that enable the source node 102 to connect to various wireless networks. For example, the source node 102 can include a network interface 128 for connecting to a short-range network 126 using WI-FI DIRECT or BLUETOOTH, and a network interface 128 for connecting to a cellular network 106. WI-FI DIRECT is a technology used by devices to connect point-to-point, without having to be connected to a common wireless network.

The source node 102 may host a splitter application 118 configured to split data received from a data source (e.g., a camera, memory 114, or data store) into data packets and distribute the data to the forwarder nodes 104 using a short-range network 126. As an example, the splitter application 118 may be started when a user of the source node 102 starts a video stream. When the splitter application 118 is first started, it connects to the gatherer server 108 using the source node's cellular network connection to a cellular network 106.

The splitter application 118 can be configured with a public address of the gatherer server 108. A network connection between the splitter application 118 and the gatherer server 122 stays open during transmission of data from the splitter application 118 acting as a control channel for transmission of the data stream. The gatherer server 108 sends feedback to the splitter application 118 about each forwarder node 104.

Using the short-range network 126, the forwarder nodes 104 connect to the splitter application 118. Wi-Fi Direct is a short-range network technology used by smartphones to connect point-to-point, without having to be connected to the same wireless network. The splitter application 118 acts as a network access point allowing forwarder nodes 104 to connect to the splitter application 118. In one example, forwarder nodes 104 discover the splitter application 118 through an operating system service discovery mechanism (e.g., ANDROID or IOS). Any number of forwarder nodes 104 can be used, and in many cases can vary from at least one to twenty or more. In one specific example, the system 100 can include one to twelve forwarder nodes 104, and in another case from two to eight forwarder nodes 104, and in one case from four to five forwarder nodes 104.

When a forwarder node 104 connects to the splitter application 118, information is sent to a forwarder application 120 hosted on the forwarder node. As an example, the information can include an internal IP address, a unique identifier for the forwarder node 104, and the IP address and port number of the gatherer server 108, allowing the forwarder application 120 to forward data packets from the splitter application 118 to the gatherer server 108. The forwarder application 120 in return can send the cost of using the forwarder node 104 to the splitter application 118. This cost metric is explained in greater detail below.

The splitter application 118 determines which forwarder nodes 104 to use based on the cost and the data rate that a forwarder node 104 can offer to the splitter application 118. The splitter application 118 itself can act as a forwarder node, using its cellular connection to send data packets to the gatherer server 108 as well as using a short-range network 126 to distribute data packets to the forwarder nodes 104. The throughputs of each forwarder node 104 can be sent as feedback from the gather server 108 to the splitter application 118. This throughput estimate can take into account both the short-range network 126 used to send the data packets to the forwarder nodes 104 and the cellular network 106 used to forward the data packets to the gatherer server 108. Accordingly, the splitter application 118 can use the throughput estimate to adjust how the data packets are distributed based in part on which network 106/126 is causing a bottleneck. The splitter application 118 can determine how much data to send to each forwarder node 104 based on a distribution method.

The gatherer server 108 acts as a proxy between the client 124 and the data being sent by the forwarder nodes 104. The gatherer server 108 can comprise a networked server having one or more processors 112, memory devices 114, a network interface 128, and the gatherer server 108 may host a gatherer application 122. In one example, the gatherer server 108 can be hosted in a computing service environment (e.g., the “Cloud”). The gatherer server 108 receives data packets from each of the forwarder nodes 104 and the splitter application 118 and provides the data packets to the gatherer application 122 configured to combine the data using the data packets. Because the data packets may be received out of order due to different network paths and network conditions, the gatherer application 122 arranges the data packets in the correct order and then sends the assembled data to the client 124 via a network 130. The network 130 may include any useful computing network, including an intranet, the Internet, a local area network, a wide area network, a wireless data network, or any other such network or combination thereof.

While gathering data, the gatherer application 122 can collect throughput statistics for each of the forwarder nodes 104. This information can be sent to the splitter application 118 through the previously mentioned control channel. This information can be used by the splitter application 118 to determine how much data to send to each forwarder node 104 and determine the value of each forwarder node 104 in the system 100.

A forwarder node 104 can comprise a mobile computing device having one or more processors 112, memory devices 114, and network interfaces 128 that enable the forwarder node 104 to connect to a short-range network 126 and a cellular network 106. As described above, a forwarder node 104 hosts the forwarder application 120. The forwarder application 120 can be configured to detect a source node 102 that hosts a splitter application 118 and connect to the splitter application 118 through a short-range network 126. As a non-limiting example, a forwarder application 120 may connect to a splitter application 118 using WI-FI DIRECT and an ANDROID operating system service discovery mechanism. After detecting the splitter application 118 hosted on the source node 102 and receiving information for forwarding data packets to a gatherer application 122 on a gatherer server 108, the forwarder application 120 hosted on the forwarder node 104 advertises the forwarder node's cost to the splitter application 118. This cost represents the cost to an owner of the forwarder node 104 to forward data packets to the gatherer server 108. Namely, costs associated with the owner's data plan, bandwidth, and battery life. The cost can be configured to change with respect to these values and can change as necessary. For example, a forwarder node 104 owner may charge more if the forwarder node's battery is getting low or if the forwarder owner's data plan has limited data remaining.

If the splitter application 118 selects the forwarder node 104, the splitter application 118 forwards data packets to the forwarder application 120, which then forwards the data packets to a gatherer application 122 hosted on the gatherer server 108 through a cellular network 106 using the forwarder node's cellular connection. As such, the forwarder application 120 utilizes the forwarder node's wireless network interface 128 (WI-FI, BLUETOOTH, and the like) to receive data from the splitter application 118 and the forwarder node's cellular radio to send data to the gatherer application 122 on the gatherer server 108, typically at the same time.

### Distribution Methods and Incentive Model

Two aspects of the present technology are how to distribute data to forwarder nodes 104 and how to motivate forwarder nodes 104 to participate in the system 100. The distribution of data to forwarder nodes 104 affects how well the system is able to stream data without interruption. The system 100 needs to be able to react quickly to changes in the data rate of the forwarder nodes 104. To get forwarder nodes 104 to be willing to forward data for the splitter application 118, an incentive can be provided. Using both of these components, the present technology is able to dynamically select which forwarder nodes 104 to distribute data to and utilize those selected forwarder nodes 104 fully.

### Distribution Methods

As described above, the splitter application 118 obtains data from a data source and distributes data packets to itself and other forwarder nodes 104. To suitably distribute data packets among different forwarder nodes 104 based on their cellular data rates, a weight can be assigned to each forwarder node 104. The assigned weights represent the number of data packets that a forwarder node 104 will receive, relative to the other forwarder nodes 104. For example, if two forwarder nodes 104, f1 and f2, have a weight of 1 and 5 respectively, then for every one packet f1 receives, f2 receives 5 packets. These weights can also be thought of as ratios, in which case f1 and f2 would have a ratio of 1:5.

There are many different approaches on how to update the weights according to the network conditions. The goal of updating the weights is to maximize the combined throughput of all of the forwarder nodes 104. Because of the dynamic nature of cellular networks, it is not always possible to have the weights set to the optimal values. In this situation, there is a trade-off between being aggressive and reacting too quickly to temporary changes. A less aggressive approach avoids changing the weight too dramatically when there is a short fluctuation in the data rate of a forwarder node 104. However, reacting too slowly in a rapidly changing environment may cause under-utilization of available bandwidth. Accordingly, three different methods can be used alone or in combination to update the weights in order to understand and evaluate this tradeoff: the linear method, the jump method, and the Kalman filter method.

Before describing each method, some principles and definitions are presented. In the context of the distribution methods, the source node 102 is also a forwarder node since in some cases the source node 102 can also send data packets and can act as a forwarder. For the methods, a forwarder node 104 can be initially assigned the lowest data rate weight of 1. A weight of 1 is the minimum that any forwarder node 104 can be assigned. This simplifies the packet distribution method.

As explained earlier, the splitter application 118 receives feedback from the gatherer application 122 hosted on the gatherer server 122. This feedback contains the actual data rate for each of the forwarder nodes 104. The splitter application 118 also knows the expected data rate of each forwarder node 104 based on the input data rate of the data source and the weight assigned to the forwarder nodes 104. For example, if the splitter application 118 is receiving 1800 Kbps of data from the data source and has two forwarder nodes 104 connected (f1 and f2) with a ratio of 1:5, the expected data rate for f1 and f2 would be 300 Kbps and 1500 Kbps respectively. Though the splitter application 118 knows the actual sending rate of each forwarder node 104, the splitter application 118 does not know what each forwarder node 104 is capable of sending. Each forwarder node 104 might be capable of sending more than what the splitter application 118 is giving to the forwarder node 104. As a result, an important feature of a weight updating method is to act as a probe, determining if any forwarder nodes 104 are capable of sending more. If the actual data rate is less than the expected data rate (e.g., with a 10% margin of error), an assumption can be made that the forwarder node 104 is at maximum capacity. In this case, the forwarder node 104 is considered to be underperforming. Using the same example above, if f2's actual data rate was 1000 Kbps, then it would be underperforming.

Finally, the splitter application 118 may update a weight if a forwarder node 104 is underperforming. If all of the forwarder nodes 104 are able to sustain their data rates, then the weights will not be updated.

### Linear Method

An example of the linear method is outlined below.

Linear distribution

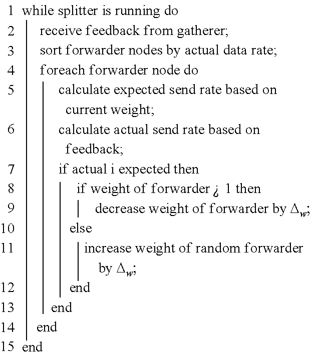

In the linear method, the ratio of data packets being distributed changes by a constant amount. The weight of each forwarder node 104 initially starts at 1. When feedback is received from the gatherer application 122, the reported data rate of each forwarder node 104 is sorted from lowest to highest. Each forwarder node 104 that is underperforming will update its weight by a constant value, Δ_{w}. If the weight of a forwarder node 104 is greater than one, its weight is decreased by Δ_{w}. If the weight of a forwarder node 104 is already at 1, then the weight of a randomly selected forwarder node 104 is increased by Δ_{w}. Because a ratio is used, by increasing another random forwarder node's weight, the data rate of all the other forwarder nodes is decreasing. A forwarder node 104 is selected randomly so that the increase is not applied to the same forwarder node 104 multiple times. This process is continued, going through each underperforming forwarder node 104 every time feedback is received from the gatherer application 122. This linear method represents the most conservative way of increasing the weights of each forwarder node 104.

Setting how much the weight changes Δ_{w}, has an significant impact on the overall behavior and performance of the method. If Δ_{w} is set too small, then the weight changes will be slow to respond to real network changes. However, if Δ_{w} is set too high, the jumps in data rate will be too big to precisely express the real data rate. In general, there is a tradeoff between an exact fit and the response time of the method.

For example, assuming two forwarder nodes, f1 and f2, distribute a data source of 1800 Kbps with a starting ratio of 1:1, Δ_{w}=1, the expected send rate will be 900 Kbps for each forwarder node. Receiving feedback from the gatherer application 122 shows that f1 and f2 are capable of sending 800 Kbps and 1000 Kbps, respectively. Following the linear method, since f1 is underperforming and its weight is already at one, f2's weight will be increased by Δ_{w}, which in this example is 1. Now that f2's weight has been increased, it is underperforming, in which case its weight will be dropped by 1, keeping the weights the same (1:1). By using a big Δ_{w} relative to the data rates, 200 Kbps of potential data rate increase is lost.

For the experiments described later in the Evaluation section, Δ_{w}=1 is used. After running preliminary results, it was found that Δ_{w}=1 has a good tradeoff between being aggressive, but still being able to express typical cellular data rates.

### Jump Method

An example jump method is outlined below.

Jump distribution algorithm

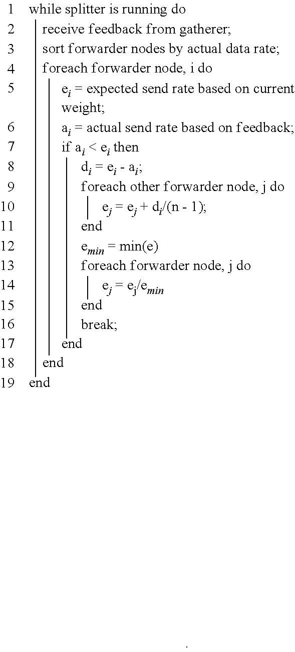

The jump method represents an aggressive way of increasing the weights for each forwarder node 104. In the jump method, the forwarder nodes 104 are sorted by the actual data rates, aᵢ. The expected data rates, eᵢ, of each forwarder node 104 is compared to aᵢ to determine if a forwarder node 104 is underperforming (aᵢ<eᵢ). When an underperforming forwarder node 104 is found, the data rate difference, dᵢ, is calculated by eᵢ−aᵢ. dᵢ is then distributed to all other forwarder nodes 104, eⱼ=dᵢ/(n-1)+e_{j ∀ j ∈ {1}, . . . , n} when j≠i. Now that each forwarder node's expected data rate has been updated, all the expected rates are converted into weights. This is first done by finding the minimum expected values, eₘᵢₙ=min{e₁, . . . , eₙ}, and dividing all expected data rates by the min: wᵢ=e₁/e_{min ∀ i ∈ 1,} . . . , n}.

Taking the same example from above, after the first round of feedback, f1's expected rate would be dropped to 800 Kbps and f2's expected rate would be increased to 1000 Kbps. In this method, the weights jump directly to the data rate a forwarder node 104 is capable of transmitting. There are potential problems with this method. By aggressively jumping to the actual data rate, this method is affected by temporary highs and lows in the data rate that don't truly represent the average data rate. Since there is some latency involved with the feedback, this could potentially decrease performance if the data rate is changing dramatically.

### Kalman Filter

The Kalman filter distribution method is similar to the jump method except that instead of jumping directly to the current data rate, it uses a Kalman Filter to smooth the predictions. A Kalman Filter estimates unknown variables through reading a stream of noisy and inaccurate data. It is recursive, meaning that it can process new entries in real-time. Because of its smoothing ability and ability to process real-time data, a Kalman Filter is a good estimator for working with noisy cellular data rate estimations.

### Incentive Model

Described at a high level is an incentive model for obtaining cooperation from forwarder nodes 104 for upstreaming data, such as live video. Cooperative bandwidth sharing is considered in the presence of selfish but rational forwarder nodes 104. A forwarder node's main goal is to maximize its profits, not to harm others. Since the forwarder nodes 104 incur costs (in the form of cellular data and phone battery and other resources) while sending data packets on behalf of the splitter application 118, they may not be willing to participate unless the splitter application 118 provides the right incentives. The gatherer application 122 acts cooperatively with the splitter application 118 and informs the splitter application 118 about the throughput statistics of the forwarder nodes 104. A simple auction is used that works as follows: the forwarder nodes 104 find a splitter application 118 to connect to and send their bids to the splitter application 118. The splitter application 118 determines the allocation rule and the payment mechanism based on the received bids and the received feedback from the gatherer application 122 about the actual data rates of the forwarder nodes 104. Essentially, the splitter application 118 assigns a score to each forwarder node 104 and chooses a certain number of forwarder nodes 104 in the decreasing order of scores constrained by the total amount it can spend for using the resources of the forwarder nodes 104. Because of the changes in the actual data rates, the splitter application 118 holds an auction when it receives feedback from the gatherer application 122. The forwarder nodes 104 also can change their bids at each auction and it is possible that the number of forwarder nodes 104 varies in different auctions because of the mobility of mobile devices. The auction provides incentive for forwarder nodes 104 to cooperate by implementing dominant equilibrium. In this setting, each forwarder node's best strategy is to report its actual cost regardless of other players' strategies.

### Example Implementation

The following is a non-limiting example of an implementation of a system as described above. In this example, a splitter application and a forwarder application of the system can be written as an ANDROID application in JAVA, although these components can also be written as an APPLE application (e.g. using Multipeer Connectivity) and can be fully implemented on an ANDROID device that supports WI-FI DIRECT and can utilize frameworks which communicate with both APPLE and ANDROID devices (e.g. custom or third-party frameworks which are similar to WI-FI DIRECT but communicate with both APPLE and ANDROID systems). For the data source component, Spydroid, an open source project that can stream a device's camera video to a client through either HTTP (HyperText Transfer Protocol) or RTSP (Real Time Streaming Protocol) is used. The gatherer application is implemented on a server in Python.

When the splitter application is initially started, it creates a TCP (Transmission Control Protocol) connection with the gatherer application. The gather application is assumed to always be accessible as it is running in a “cloud” computing environment. This connection acts as a way for control messages to be sent back and forth between the splitter application and the gatherer application. For a client to connect to a data source, it connects through the gatherer application. The gatherer application forwards all messages from a client to the splitter application. The splitter application then forwards messages to the data source. During the initial RTSP connection establishment (RTSP OPTIONS and DESCRIBE), both the splitter application and the gatherer application act as transparent layers. During the RTSP SETUP message exchange, the splitter application changes the port number of the client port field in the request to a port that it has open and the gatherer application changes the port number of the server port field to a port that it has open.

When the RTSP connection has been established and data packets start being sent to the splitter application from the data source, the splitter application distributes the packets based on the available data rate of each of the forwarder nodes. To keep track of the ordering of the data packets, a sequence number is added to each data packet. The splitter application adds the MAC address of the forwarder node it is using to send the data packet. This allows the gatherer application to keep statistics of how each forwarder node is performing. The gatherer application calculates the throughput of each forwarder node and sends this back as feedback to the splitter application. Based on the feedback, the splitter application changes the weightings of the forwarder nodes to match their actual data rate. The gatherer application sends feedback to the splitter application every 100 ms. The weight of the forwarder node and the send time are also added to the packet header for debugging and data collection purposes.

The gatherer application buffers received data packets to make sure they are in order. Once data packets are in the right sequential order, it sends the ordered data packets to the client. Because RTP was used, which uses UDP (User Datagram Protocol), there is no way of telling if a data packet has been dropped or if it is still in transition. This presents a problem to the gatherer application to know if it should wait for a missing data packet to arrive or skip it. To solve this, individual queues are kept for each forwarder node. When a data packet is received, it is put into its corresponding queue. If sequence numbers of all the heads of the different queues is greater than the sequence number of the data packet in question, then it is known that the data packet must have either been lost or severely reordered by the network and can be counted as a loss. This allows the gatherer application to skip that data packet and continue to put the rest of the data packets in order.

In the case that video is being streamed, if the aggregate data rate of the cellular links is below the data rate of the video, then the video packets are purposefully dropped. A sophisticated video application is expected to adaptively adjust its video quality to match the output data rate.

### Evaluation

The present technology was evaluated using trace-driven simulations and an implementation on smartphone devices. There are three purposes for evaluating the present technology in simulation. The first is to develop and understand the interaction between the video distribution methods and the incentive mechanisms. Second, to determine the best parameters for the distribution methods. Third, test the design with a large number of forwarder nodes under various conditions.

Use data traces comprising of cellular data rates under different indoor and outdoor conditions were collected to drive the simulation. The cellular data traces were collected by sending data from a cellular phone to a server at 20 Mbps, well above the data rate the cellular link is capable of sending. The actual throughput of the cellular device is recorded by the server where the data is being sent. The actual throughput and its fluctuations are used in the simulator and wireless testbed.

The splitter application and forwarder application components were collected as an ANDROID application in JAVA on two Samsung Galaxy S4 phones. The gatherer application was implemented on a server in PYTHON. The implementation was used in the following two ways. First, an emulation platform was created that emulates cellular forwarder nodes using WI-FI, i.e., the forwarder nodes transmit data using WI-FI (and not a cellular network). Here, as in the simulation, the transmit data rate of the forwarder nodes was determined using traces. However, unlike the simulation, live video transmission from ANDROID devices to the gatherer application was used. The purpose of the emulation is to validate the implementation in a more realistic setting (compared to the simulation), while still having a controlled environment.

Finally, the implementation with WI-FI DIRECT and cellular links in a real world live video transmission during a commuter train ride was used to evaluate the benefits of the approaches in real time under real conditions. The results of the simulation, implementation, and commuter train ride are presented below.

### Simulation-Based Evaluation

The following describes simulations that were conducted using the present technology. A custom simulator was built using PYTHON. Cellular data traces were collected to provide realistic cellular characteristics, such as data rates and changes in data rate. Using the simulator, different configurations of forwarder nodes and distribution methods were tested. To evaluate a distribution method, three metrics were used: average throughput, variance, and percent above maximum data rate. Average throughput was measured to determine a distribution method that can take advantage of any available data rate. It is also desirable to identify a distribution method that does not fluctuate unnecessarily. Lastly, a method is avoided that estimates a data rate that is higher than the maximum data rate, which can lead to reordering issues and buffering of video. Percent below maximum data rate quantifies this problem. All of these metrics are relative to what data set they are given so results can be compared when dealing with the same data set.

Results for two configurations are shown using a wireless trace with three forwarder nodes and eight forwarder nodes. Table 1 shows the results of using three forwarder nodes and Table 2 shows the results of using eight forwarder nodes.

TABLE 1
Simulation results with 3 forwarders.

| | Mean Tput | | % Below |
|---|---|---|---|
| Distribution | (Kbps) | Variance | Max |
| Linear | 1927.3 | 0.393 | 86.7% |
| Jump | 1937.3 | 0.298 | 90.7% |
| Kalman | 1945.9 | 0.257 | 88.6% |

TABLE 2
Simulation results with 8 forwarders.

| | Mean Tput | | % Below |
|---|---|---|---|
| Distribution | (Kbps) | Variance | Max |
| Linear | 3050.1 | 0.491 | 43.7% |
| Jump | 3172.6 | 0.481 | 53.5% |
| Kalman | 3168.7 | 0.407 | 49.8% |

The results of the simulations (not all shown here) show that the jump distribution method has the highest average throughput and the highest percentage above the maximum throughput. The second highest is the Kalman filter distribution method. The Kalman filter also has the least amount of variance compared to the other methods. This intuitively makes sense given that the jump method follows the changes in data rate very aggressively, causing it to have the highest average throughput, but reacting too quickly to short-term fluctuations. Kalman filter smooths out short term changes in date rate, making it the most stable, but it is unable to capture all potential data rates as a result.

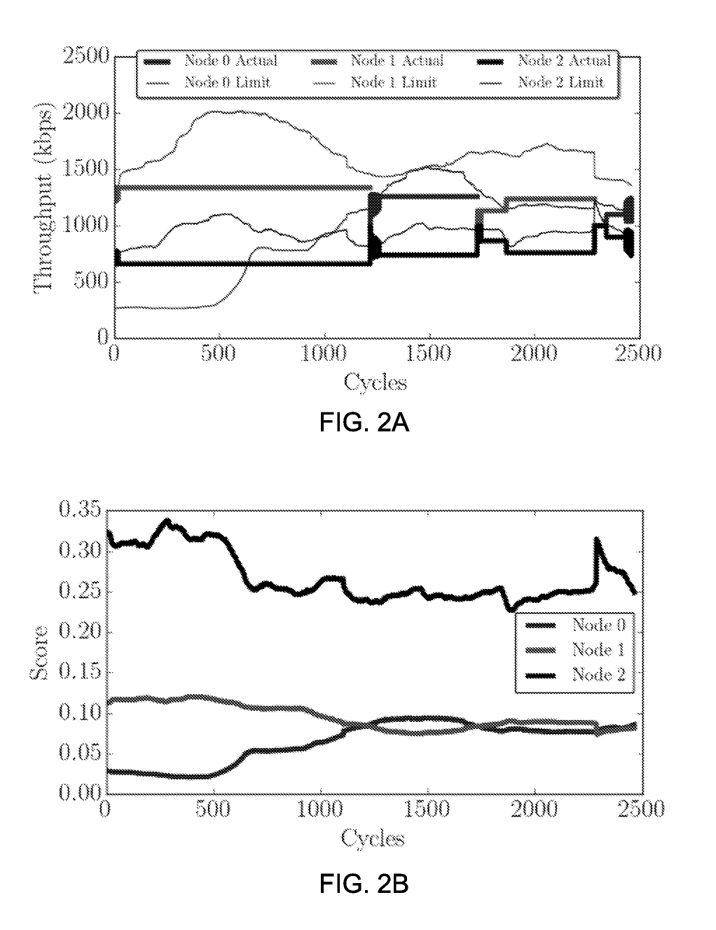

The results in FIGS. 2a-b show how the incentive model interacts in the simulator. In this simulation, only three forwarder nodes are used. FIG. 2a shows the data rate limit of each of the forwarder nodes (thick line) in relation to the data rate the distribution method has selected (thin line). FIG. 2b shows the score of each forwarder node. As the scores of the forwarder nodes change (based on how much data rate they can provide and their cost), the splitter application selects different forwarder nodes that can maximize the aggregate data rate and stay under its budget. In FIG. 2b, this occurs at cycle 1250 and 1750. This shows that the splitter is able to dynamically select the best set of forwarder nodes that can provide the best value to it.

### Wireless Testbed Evaluation

In this section, the performance of the present technology is evaluated under three different scenarios. For the testbed, instead of using cellular connections to send data to the gatherer application, WI-FI is used. The testbed allows for the data rate of individual forwarder nodes to be set for a specific amount of time. Using the testbed, emulation of many different data rate conditions can be performed to determine how the system reacts. The first scenario keeps the data rates constant for the wireless nodes (i.e., the source node hosting the splitter application and the forwarder nodes). The second scenario changes the data rate of each of the wireless nodes, testing how our system reacts to changes in cellular conditions. The final scenario, a previously collected cellular trace was played back to test how the system responds to actual conditions.

To measure the effectiveness of the present technology, two metrics were used: video throughput and jitter. Video throughput is the rate at which the gatherer application can send video data to the client, once all the ordered data packets have been received. Video throughput indirectly captures the effect of out-of-order data packets because out-of-order data packets are buffered before they are sent to the client.

For each of the scenarios, each distribution method was tested. Accordingly, used with the linear distribution method, was set to 1. For the experiments, the average video output rate (from the data source) was 2,000 Kbps. Table 3 summarizes the data for each scenario, showing the first, middle, and last quartile for video throughput and jitter. A more detailed discussion of the results is presented below.

TABLE 3
Summary of experiment results.

| | | Throughput (Kbps) | | | Jitter (ms) | | |
|---|---|---|---|---|---|---|---|
| Scenario | Distribution | 25% ile | Median | 75% ile | 25% ile | Median | 75% ile |
| Constant | One Phone | 204 | 234 | 257 | 0.134 | 0.958 | 79.030 |
| | Linear | 2191 | 2216 | 2246 | 2.808 | 3.300 | 7.055 |
| | Jump | 2175 | 2206 | 2234 | 2.819 | 3.267 | 5.836 |
| | Kalman | 739 | 830 | 943 | 2.796 | 3.5 | 4161 |
| Varied Data Rate | One Phone | 2163 | 2242 | 2310 | 0.03695 | 0.067 | 0.1879 |
| | Linear | 650 | 2027 | 2191 | 0.086 | 2.113 | 55.158 |
| | Jump | 2148 | 2200 | 2241 | 0.095 | 1.854 | 5.952 |
| | Kalman | 1664 | 2227 | 2258 | 2.331 | 3.795 | 21.44 |
| Indoor Cell Trace | One Phone | 509 | 553 | 630 | 5.655 | 11.670 | 27.940 |
| | Linear | 446 | 605 | 898 | 9.235 | 4338.0 | 10960.0 |
| | Jump | 739 | 1067 | 1466 | 8.531 | 716.7 | 3895.0 |
| | Kalman | 579 | 749 | 995 | 12.58 | 2379.0 | 0.818 |
| Train | One Phone | 1435 | 1838 | 1953 | 0.117 | 0.448 | 1.441 |
| | Jump | 2340 | 3077 | 3142 | 0.364 | 1.452 | 17.460 |

### Constant Data Rate

In the constant rate scenario, the data rate of the source node hosting the splitter application was limited to 360 Kbps and the data rate of the forwarder node was 6 Mbps. Based on a study of throughput characteristics of cellular networks, 360 Kbps and 6 Mbps were selected because they roughly represent the lower bound and average cellular bandwidth. The big difference in the data rate between the source node and forwarder node help to illustrate any potential problems with out of order packets.

The purpose of this experiment is to test how well the methods are able to adapt to the low data rate of the source node. Both the source node and the forwarder node start out with equal weights, so the method detects the small data rate of the source node and adjust the weights. If the method is slow to react, video packets become out of order, causing the video throughput to drop.

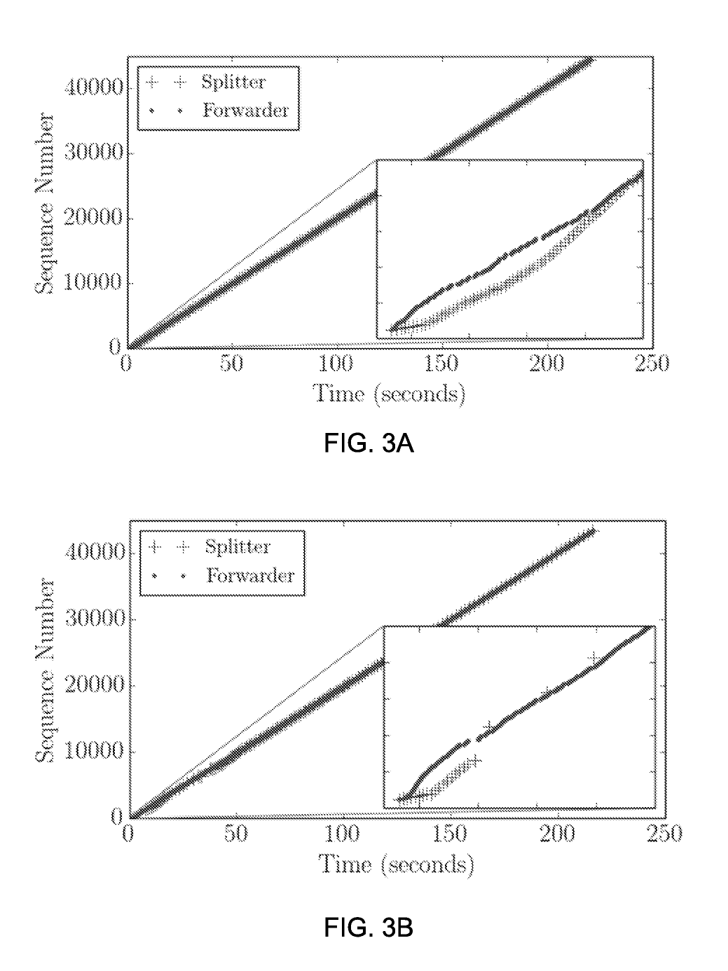

FIGS. 3a-b show the video packets that are received by the gatherer application sorted by their sequence number with respect to time. FIG. 3a and FIG. 3b correspond to the linear and jump distribution methods, respectively. From the perspective of the whole experiment, it is hard to distinguish the difference between the video packets sent by the splitter application and the forwarder application. For most of the graph, they stay close together, which is ideal behavior. The zoomed in portion of the graphs shows the first 500 sequence numbers sent by the splitter application and forwarder application. The graphs show that the linear distribution method takes about two seconds to adjust the weights to match the source node's data rate. The jump distribution method adjusts the weights to match the source node's data rate almost instantaneously. The jump method is more prone to reacting to loss and noise. This can be seen in the jump portion of FIG. 3b at 38 seconds. The linear method is more stable because it takes a greater change in data rate for it to change the weight of one of the wireless nodes. It is important that a distribution method react quickly to changes because cellular data rates are known to fluctuate quickly.

In both cases, the aggregate data rate is much higher than the data rate of the source node by itself. The median video throughput for both methods is roughly 2200 Kbps which is close to the ideal video throughput of 2300 Kbps. The jump and linear methods have a higher video throughput than one phone 90.15% and 99.95% of the time, respectively.

### Varied Data Rate

In this scenario, the data rate of the source node and forwarder node start at 360 Kbps and 6 Mbps, respectively. After 60 seconds, the source node's data rate increases to 6 Mbps. After 120 seconds, the forwarder node's data rate decreases to 360 Kbps. The reasoning behind making the difference in data rate so large is the same as explained in the previous section.

The purpose of this scenario is to see how quickly the system can respond to changes in data rate. In this case, the changes occur at the 60 and 120 second marks. This scenario also tests how much the video throughput is affected by these network changes.

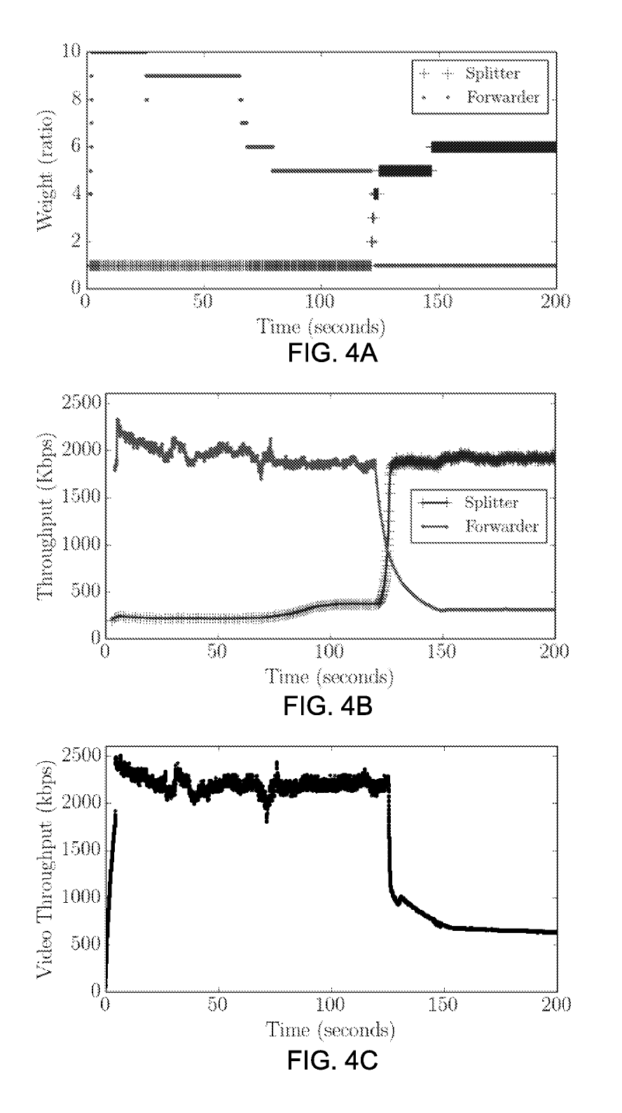

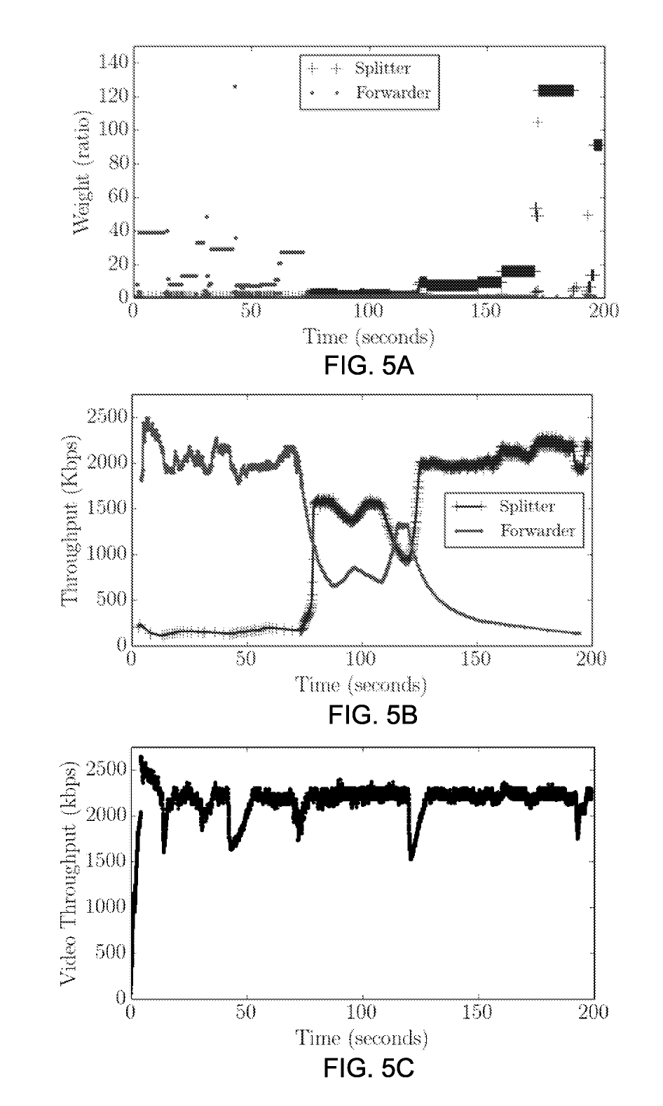

FIGS. 4a-c and FIGS. 5a-c show the results of the experiment for the linear and jump distributor, respectively. Fluctuations in the weights of the jump method cause video throughput to dip in certain places (at 15, 45, 72, and 121 seconds on FIG. 5c). Even with the dips, the median video throughput is 2200 Kbps. The results show that both the linear and jump distribution methods are capable of delivering an aggregate data rate higher than the individual data rates. The linear method delivers a higher rate 87.70% of the time whereas the linear method delivers a higher rate only 57.26% of the time. The jump method is more expressive than the linear method and can better fine-tune itself to match the network conditions. This can be seen in FIGS. 4a-c, where the weight the linear distributor selects does not take advantage of the extra bandwidth, lowering the video throughput.

It is also interesting to note that because the linear distributor tries to remain in steady state, it does not change weights until is forced to (at 130 seconds). The jump distributor adjusts immediately to the extra throughput (at 80 seconds). This shows the jump distributor's tendency to try to keep the weights even. Since these methods are best effort, there are times when the aggregate data rate might drop below one individual data rate.

The data rates used in this scenario are calculated from a cellular trace. Data was collected to measure the maximum throughput of two cellular links at the same time. The maximum throughputs were then entered into the wireless testbed to emulate the cellular environment.

In this particular trace, the data rates change dramatically and at a rapid pace. The trace was collected deep inside a building where cellular connectivity fluctuates. The rapid changes make it harder for the distribution method to determine the data rate of each forwarder node and as a result, at some points, the aggregate video throughput is less than an individual forwarder node's throughput.

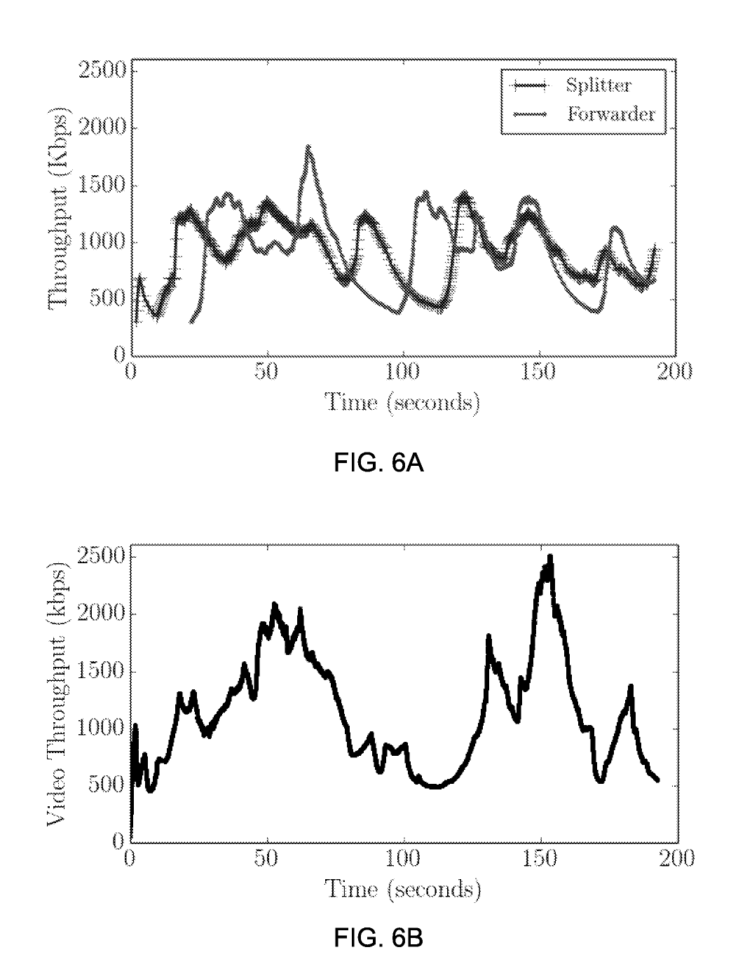

The throughputs of the source node and forwarder node and the video throughput are shown for jump method in FIGS. 6a-b. The jump method performs better in both video throughput and jitter compared to the other methods (see Table 3). It is able to maintain a higher video throughput compared to a single device 67.98% of the time.

The system was tested in a dynamically changing environment that included a train traveling between different cities. The train travels up to 79 mph and makes a stop roughly every 8 miles. The test of the system was directed to an actual and changing environment, where mobility would be an important factor. A total of 90 miles were traveled, collecting data along the way, using two devices, one device acting as a source node and forwarder node, and another device acting as a forwarder node. The jump distribution method was selected to fully implement and test because it consistently has the highest average data rate and least amount of jitter. Interesting results of the test are presented below.

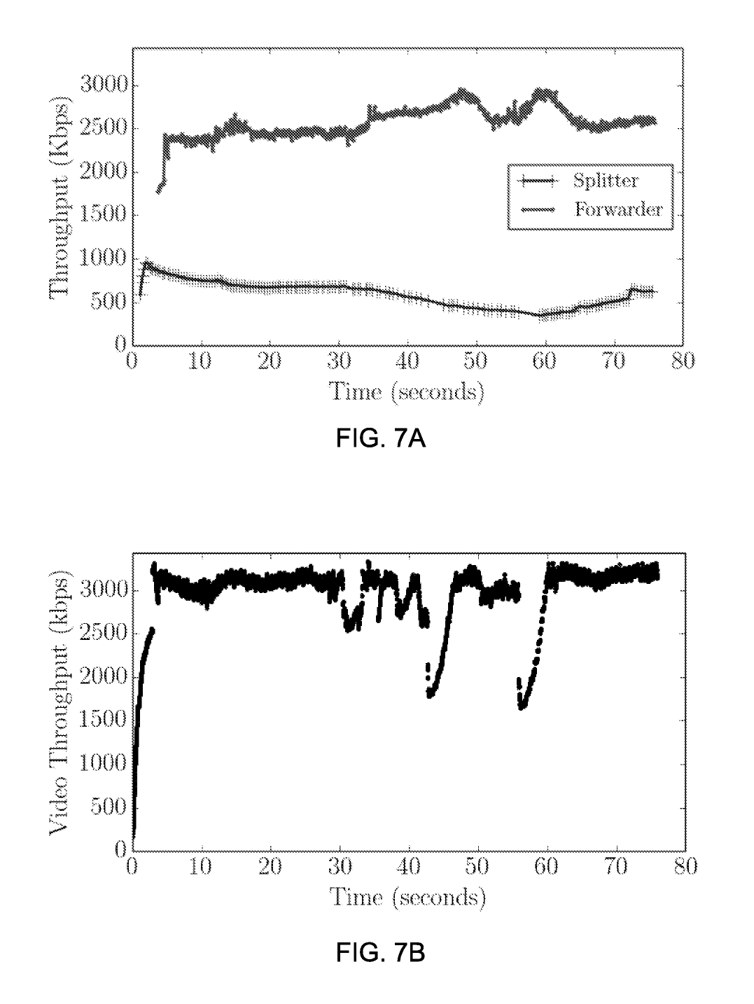

FIGS. 7a-b show throughput of each of the source and forwarder nodes as well as the actual throughput of the video for the jump distributor. In FIG. 7a the throughput of one of the forwarder nodes decreases while the other one increases, picking up the extra data to maintain the same data rate. The video throughput shown in FIG. 7b exceeds the throughput of both the forwarder nodes, except for two instances. Examination of the logged data, revealed that both of these instances correspond to network loss.

FIGS. 7a-b only shows a small portion of the data collected on the train, while Table 3 takes into account all of the data collected on the train. The results of this experiment show that the present technology is capable of producing almost ideal aggregate throughput in real network conditions. The present technology performs better than a single device 88.6% of the time with the jump method.

The simulations showed that the present technology typically results in a higher video throughput when compared to video throughput using a single device. Specifically, the jump method typically performs better than other methods. Even though the jump method is susceptible to erroneous weight changes, the jump method was shown to be able to adapt to actual conditions by rapidly changing data rates and taking advantage of multiple connections to deliver a higher video throughput to the client. The stability of the Kalman filter can hinder it from reacting quickly enough under actual-use network conditions.

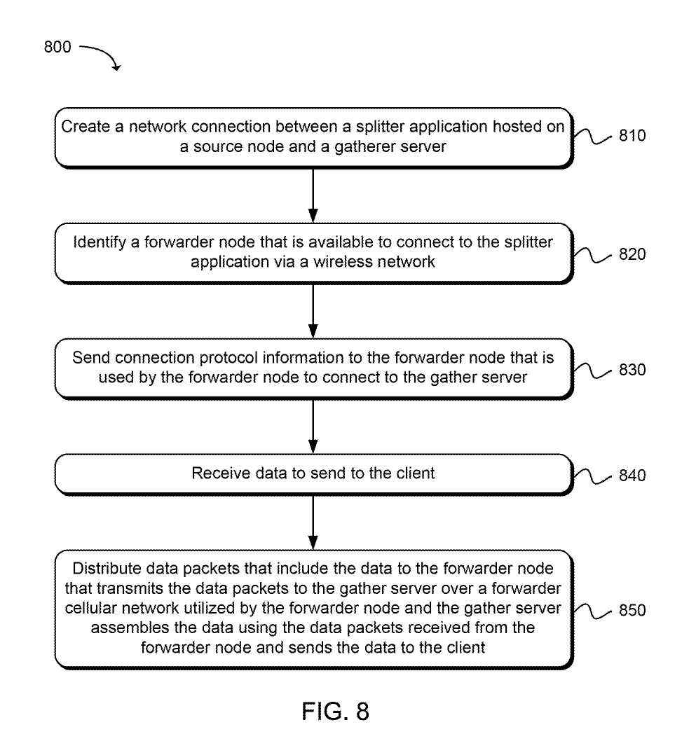

FIG. 8 is a flow diagram illustrating an example method 800 for streaming data to a client. As in block 810, a network connection may be created between a splitter application and a gatherer server, where the network connection acts as a control channel for the splitter application and the gatherer server to manage transmission of the streaming data from a source node to a client.

As in block 820, a forwarder node available to connect to the splitter application via a wireless network may be identified. As in block 830, connection protocol information may be sent to the forwarder node that may be used by the forwarder node to connect to the gather server.

As in block 840, data may be received from a data source, and as in block 840, data packets that include the data may be distributed to the forwarder node via the wireless network, and the forwarder node transmits the data packets to the gather server over a forwarder cellular network utilized by the forwarder node and the gather server assembles the data using the data packets received from the forwarder node and sends the data to the client.

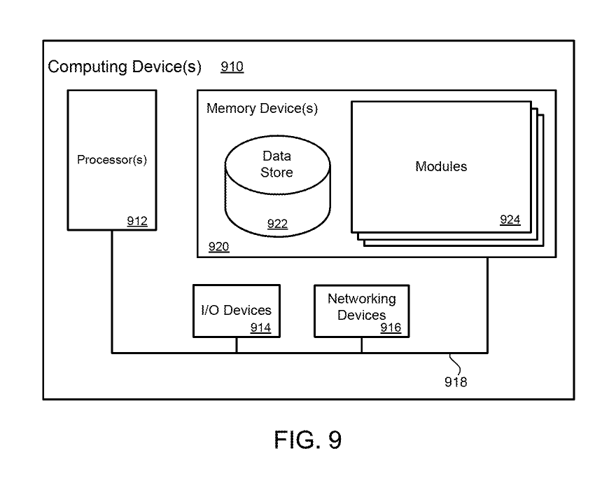

FIG. 9 illustrates a computing device 910 on which modules of this technology may execute. A computing device 910 is illustrated on which a high level example of the technology may be executed. The computing device 910 may include one or more processors 912 that are in communication with memory devices 920. The computing device 910 may include a local communication interface 918 for the components in the computing device. For example, the local communication interface 918 may be a local data bus and/or any related address or control busses as may be desired.

The memory device 920 may contain modules 924 that are executable by the processor(s) 912 and data for the modules 924. For example, the memory device 920 can include a splitter application module, a forwarder application module, or a gatherer application module. The modules 924 may execute the methods described earlier. A data store 922 may also be located in the memory device 920 for storing data related to the modules 924 and other applications along with an operating system that is executable by the processor(s) 912.

Other applications may also be stored in the memory device 920 and may be executable by the processor(s) 912. Components or modules discussed in this description that may be implemented in the form of software using high programming level languages that are compiled, interpreted or executed using a hybrid of the methods.

The computing device may also have access to I/O (input/output) devices 914 that are usable by the computing devices. Networking devices 916 and similar communication devices may be included in the computing device. The networking devices 916 may be wired or wireless networking devices that connect to the internet, a LAN, WAN, or other computing network.

The components or modules that are shown as being stored in the memory device 920 may be executed by the processor(s) 912. The term “executable” may mean a program file that is in a form that may be executed by a processor 912. For example, a program in a higher level language may be compiled into machine code in a format that may be loaded into a random access portion of the memory device 920 and executed by the processor 912, or source code may be loaded by another executable program and interpreted to generate instructions in a random access portion of the memory to be executed by a processor. The executable program may be stored in any portion or component of the memory device 920. For example, the memory device 920 may be random access memory (RAM), read only memory (ROM), flash memory, a solid state drive, memory card, a hard drive, optical disk, floppy disk, magnetic tape, or any other memory components.

The processor 912 may represent multiple processors and the memory device 920 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer, and similar systems.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A computer implemented method for transmitting streaming data to a client, comprising:
creating a network connection between a source node and a gatherer server, wherein the network connection acts as a control channel for managing transmission of the streaming data from the source node to the client;
identifying a forwarder node that is available to forward data to the gatherer server, wherein the forwarder node connects to the source node via a wireless network;
sending connection protocol information to the forwarder node that is used by the forwarder node to connect to the gather server;
receiving data from a data source;
generating data packets that include the data; and
distributing a portion of the data packets to the forwarder node via the wireless network, wherein the forwarder node transmits the data packets to the gather server over a forwarder cellular network utilized by the forwarder node and the gather server assembles the data using the data packets received from the forwarder node and the source node and sends the data to the client.

2. A method as in claim 1, further comprising receiving a public Internet Protocol (IP) address for the gather server that enables the creation of the network connection between the source node and the gatherer server.

3. A method as in claim 1, further comprising receiving feedback for the forwarder node from the gather server over the control channel.

4. A method as in claim 1, further comprising receiving network throughput information for the forwarder node from the gather server over the control channel.

5. A method as in claim 1, wherein the forwarder node discovers the source node using a service discovery protocol that allows the forwarder node to detect the source node on the wireless network.

6. A method as in claim 1, wherein the wireless network is a wireless peer-to-peer network.

7. A method as in claim 1, wherein the connection protocol information sent to the forwarder node includes an internal IP address for the source node, a unique identifier assigned to the forwarder node by the splitter application, and an IP address and port number of the gatherer server.

8. A method as in claim 1, further comprising sending the data packets to the gather server via a source node cellular network.

9. A method as in claim 1, further comprising calculating a throughput estimate for the forwarders nodes based on feedback that takes into account both Wi-Fi network throughput and cellular network throughput.

10. A method as in claim 1, further comprising calculating a number of data packets to send to the forwarder node based in part on a data packet distribution technique.

11. A method as in claim 1, wherein the gather sever collects throughput statistics for the forwarder node and sends the throughput statistics to the source node via the control channel.

12. A method as in claim 11, further comprising determining a number of data packets to send to the forwarder node based in part on throughput statistics for the forwarder node.

13. A method as in claim 1, further comprising assigning a weight to the forwarder node that represent a number of data packets that the forwarder node is able to transmit to the gather server.

14. A system for transmitting a video stream to a client, comprising:
a processor;
a memory device including instructions that, when executed by the processor, cause the system to:
create a network connection over a cellular network between a splitter application executing on a source node and a gatherer server, wherein the network connection acts as a control channel for the splitter application and the gatherer server to send a video stream to a client;
identify forwarder nodes that are available to the splitter application via a wireless network connection that allows the forwarder nodes to connect to the source node;
send connection protocol information to the forwarder nodes that allows the forwarder nodes to connect to the gather server over at least one forwarder cellular network utilized by the forwarder nodes;
receive video stream data generated by a camera included in the source node; and
distribute video stream packets that include the video stream data to the forwarder nodes according to a forwarder node cost via the wireless network, wherein the forwarder nodes transmit the video stream packets to the gather server over the at least one forwarder cellular network utilized by the forwarder nodes and the gather server assembles the video stream using the video stream packets received from the forwarder nodes and transmits the video stream to the client.

15. A system as in claim 14, wherein the forwarder nodes are selected by the splitter application using an auction wherein the forwarder nodes submit bids to the splitter application and the splitter application selects the forwarder nodes based in part on the bids.

16. A system as in claim 14, wherein the memory device includes instructions that, when executed by the processor, causes the system to further:
assign weights to the forwarder nodes based on the forwarder node throughput; and
adjust the weights based in part on changes to the forwarder node throughput using a linear distribution technique.

17. A system as in claim 14, wherein the memory device includes instructions that, when executed by the processor, causes the system to further:
assign weights to the forwarder nodes based on forwarder node throughput; and
adjust the weights based in part on changes to the forwarder node throughput using a jump distribution technique.

18. A non-transitory machine readable storage medium having instructions embodied thereon, the instructions when executed by a processor:
create a network connection over a cellular network between a source node and a gatherer server, wherein the network connection acts as a control channel for transmitting streaming data from the source node to a client;
identify at least one forwarder node that is available to connect to the source node via a wireless network, wherein the source node acts as a network access point for the wireless network that allows the at least one forwarder node to connect to the source node;
send connection protocol information to the at least one forwarder node that is used by the at least one forwarder node to connect to the gather server;
receive video data from a video data source;
distribute a portion of video data packets that include the video data to the at least one forwarder node via the wireless network, wherein the at least one forwarder node sends the portion of the video data packets to the gather server over a forwarder cellular network utilized by the at least one forwarder node; and
send a remaining portion of the video data packets to the gather server over a source node cellular network utilized by the source node, wherein the gatherer server assembles the video data using the video data packets received from the source node and the at least one forwarder node and transmits the video to the client.

19. A non-transitory machine readable storage medium as in claim 18, wherein the instructions that when executed by the processor further receive from the at least one forwarder node a cost of using the at least one forwarder node to transmit the video data packets to the gather server, wherein the cost is determined by the at least one forwarder node based in part on a cellular data plan for the at least one forwarder node, cellular data bandwidth for the at least one forwarder node, and battery capacity for the at least one forwarder node.

20. A non-transitory machine readable storage medium as in claim 18, wherein the instructions that when executed by the processor further determine to use the at least one forwarder node based in part on a cost of using the at least one forwarder node to transmit the video data packets to the gather server.
